(19) United States
(12) Patent Application Publication
(10) Pub. No.: US 2026/0197869 A1
(43) Pub. Date: Jul. 9, 2026

(54) WIRELESS COMMUNICATION APPARATUS AND CONTROL METHOD

(71) Applicant: NTT, Inc., Tokyo (JP)

(72) Inventors: Kazumitsu SAKAMOTO, Musashino-shi (JP); Yosuke FUJINO, Musashino-shi (JP); Yohei KATAYAMA, Musashino-shi (JP); Kohei SUZAKI, Musashino-shi (JP); Kenji SUZUKI, Musashino-shi (JP)

(73) Assignee: NTT, Inc., Tokyo (JP)

(21) Appl. No.: 19/120,908

(22) PCT Filed: Oct. 24, 2022
(86) PCT No.: PCT/JP2022/039499

§ 371 Date: Apr. 14, 2025

(51) Int. Cl. H04W 74/0816; H04W 16/14

(52) U.S. Cl. CPC H04W 74/0816; H04W 16/14

(57) ABSTRACT

One aspect of the present invention is a wireless communication apparatus, including: a carrier sensor that performs carrier-sensing before transmission of a signal with respect to a transmission channel of the wireless communication apparatus and performs carrier-sensing before transmission of a signal with respect to a channel used by a reader of a passive tag system; and a controller that orders signal transmission standby based on a result of carrier-sensing performed by the carrier sensor.

### TECHNICAL FIELD

The present invention relates to a technology of a wireless communication apparatus and a control method.

### BACKGROUND ART

In general, IoT terminals use unlicensed bands and have a carrier-sense function (see NPL 1) in a transmission channel to prevent interference between terminals. Depending on the use case, communication of the passive tag system must be prioritized while sharing the active wireless system and the passive tag system which have not been assumed conventionally. FIGS. 9 and 10 are tables created by extracting a part of a 920 MHz band channel allocation table. As shown in FIG. 10, for example, in the 920 MHz band, since the range of 920.5 MHZ to 923.5 MHz is the common frequency band, interference occurs in this frequency band.

### CITATION LIST

### Non Patent Literature

NPL 1: ARIB STD-T108 Version 1.4

### SUMMARY OF INVENTION

### Technical Problem

When the mirror subcarrier scheme is used in the passive tag system in a case where the active wireless system and the passive tag system are required to be shared in the same frequency band, since a response signal from the passive tag to the reader/writer is weak, it is rare that the carrier-sensing of the IoT terminal of the active wireless system operates.

An example is considered in which the passive tag system of the 920 MHz band uses the mirror subcarrier scheme, the reader/writer of the passive tag system transmits a power supply signal to the passive tag through a power supply channel of Ch. 23 of the 920 MHz band channel allocation table (center frequency of 920.4 MHz) (see FIG. 9), the passive tag transmits a response signal to the reader/writer through data return channels of Ch. 24 to 28 (center frequencies of 920.6, 920.8, 921.0, 921.2, 921.4 MHz) (see FIG. 10), and the IoT terminal of the active wireless system transmits a signal through Ch. 24 to 28.

In this example, since the passive tag and the IoT terminal transmit signals using the same channels (Ch.24 to 28) as described above, interference occurs if the passive tag and the IoT terminal transmit signals simultaneously. Thus, the IoT terminal performs carrier-sensing before signal transmission, confirms that there is no other wireless terminal transmitting a signal through the same channel in the periphery, and then transmits a signal.

However, the response signal from the passive tag to the reader/writer is weak based on the assumption that the distance between the passive tag and the reader/writer for communication therebetween is generally a short distance of approximately several meters, the range in which the IoT terminal can perform carrier-sensing on the response signal is extremely narrow, such as approximately several meters to several tens of meters, and the IoT terminal away by several tens of meters or more transmits a signal without being able to detect the response signal of the passive tag.

In a case where the IoT terminal transmits a signal without having the carrier-sensing operated, there is a possibility of interference with a response signal of a passive tag present within several hundreds of meters or several kilometers from the IoT terminal, as shown in FIG. 8. In this case, communication of the passive tag system becomes impossible until communication of the IoT terminal ends.

In view of the above circumstances, an object of the present invention is to provide a technique capable of favorably sharing an active wireless system and a passive tag system.

### Solution to Problem

One aspect of the present invention is a wireless communication apparatus, comprising: a carrier sensor that performs carrier-sensing before transmission of a signal with respect to a transmission channel of the wireless communication apparatus and performs carrier-sensing before transmission of a signal with respect to a channel used by a reader of a passive tag system; and a controller that orders signal transmission standby based on a result of carrier-sensing performed by the carrier sensor.

One aspect of the present invention is a control method of a wireless communication apparatus, the control method comprising: a carrier-sensing step of performing carrier-sensing before transmission of a signal with respect to a transmission channel of the wireless communication apparatus and performing carrier-sensing before transmission of a signal with respect to a channel used by a reader of a passive tag system; and a control step of ordering signal transmission standby based on a result of carrier-sensing performed in the carrier-sensing step.

### Advantageous Effects of Invention

According to the present invention, an active wireless system and a passive tag system can favorably be shared.

### BRIEF DESCRIPTION OF DRAWINGS

FIG. 1 is a diagram showing a wireless communication system.

FIG. 2 is a diagram showing a frequency domain of each channel.

FIG. 3 is a diagram showing an example of a band to be subjected to carrier-sensing.

FIG. 4 is a sequence diagram showing a flow of processing performed when a power supply signal is detected.

FIG. 5 is a diagram for explaining a guideline for designing a carrier-sense level.

FIG. 6 is a diagram showing an example of setting a carrier-sense level.

FIG. 7 is a flowchart showing a flow of processing of the wireless communication apparatus.

FIG. 8 is a diagram showing an example of interference occurring between an active wireless system and a passive tag system.

FIG. 9 is a table created by extracting a part of a 920 MHz band channel allocation table.

FIG. 10 is a table created by extracting a part of the 920 MHz band channel allocation table.

### DESCRIPTION OF EMBODIMENTS

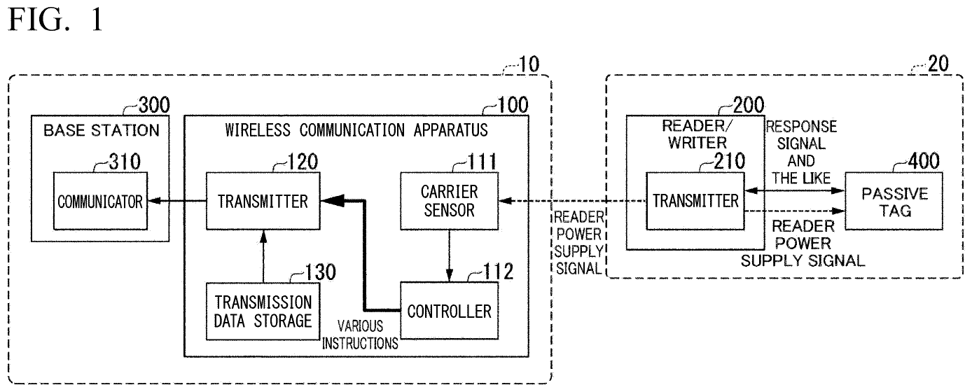

Embodiments of the present invention will be described in detail with reference to the accompanying drawings. FIG. 1 is a diagram showing a wireless communication system 1. The wireless communication system 1 comprises an active wireless system 10 and a passive tag system 20. The active wireless system 10 includes a wireless communication apparatus 100 and a base station 300 according to the present embodiment. The passive tag system 20 comprises a reader/writer 200 and a passive tag 400. Although a reader/writer is used in the present embodiment, the reader/writer 200 may be replaced by a reader/writer having only a reader function. The wireless communication apparatus 100 is, for example, an IOT (Internet of Things) terminal or a communication apparatus provided in the IoT terminal.

The wireless communication apparatus 100 includes a carrier sensor 111, a controller 112, a transmitter 120, and a transmission data storage 130. The carrier sensor 111 includes a receiving function for receiving signals corresponding to respective channels, such as a channel through which the reader/writer 200 transmits a power supply signal (hereinafter referred to as “power supply channel”).

The carrier sensor 111 performs carrier-sensing before transmission of a signal with respect to a transmission channel of the wireless communication apparatus 100 and performs carrier-sensing before transmission of a signal with respect to the power supply channel used by the reader/writer 200 of the passive tag system 20. The carrier sensor 111 may perform carrier-sensing on a plurality of power supply channels in order in a time-division manner. Alternatively, the carrier sensor 111 may have a plurality of carrier sensors mounted thereon which may carry out carrier-sensing in parallel.

The controller 112 instructs the transmitter 120 to wait for signal transmission based on the result of carrier-sensing performed by the carrier sensor 111 (whether or not a signal of the transmission channel of the wireless communication apparatus 100 or a signal of the power supply channel is detected). The controller 112 instructs the transmitter 120 to stop signal transmission based on the result of carrier-sensing performed by the carrier sensor 111 (whether or not a signal of the power supply channel is detected) during signal transmission.

The transmitter 120 transmits a signal to the base station 300, waits for transmission of the signal, and stops transmission of the signal, based on various instructions from the controller 112. Specifically, when instructed by the controller 112 to transmit a signal, the transmitter 120 starts transmission of a signal to the base station 300. When instructed by the controller 112 to stop transmission of a signal, the transmitter 120 stops transmission of a signal to the base station 300. During transmission of a signal to the base station 300, the transmitter 120 stops the transmission of the signal when instructed to wait for the signal transmission, and transmits the signal after waiting for a predetermined period of time. The transmission data storage 130 stores data to be put on a signal transmitted by the transmitter 120. The base station 300 includes a communicator 310. The communicator 310 receives a signal transmitted from the transmitter 120. In the following description, a signal transmitted by the transmitter 120 may be expressed as “own signal.”

The reader/writer 200 includes a transmitter 210. The transmitter 210 transmits a signal of a power supply channel to the passive tag 400, and transmits, for example, a signal for ordering reading and writing of data. The passive tag 400 is, for example, an RFID (Radio Frequency Identification) tag.

During communication between the reader/writer 200 and the passive tag 400, narrow-band power supply signals are continuously transmitted from the reader/writer 200 to the passive tag 400. Since a transmitting antenna of the wireless communication apparatus 100 and an antenna for carrying out carrier-sensing (hereinafter referred to as “CS antenna”) are close to each other, the own signal is strongly received by the CS antenna. Therefore, by setting a narrow bandwidth for carrier-sensing, a power supply signal power can be observed as usual while reducing a transmission signal power in the band for carrier-sensing. Thus, the transmission stop operation corresponding to the presence/absence of the power supply signal can be performed without malfunction due to the own signal. It is preferable that the bandwidth for carrier-sensing be set as narrow as possible within a range in which a transmission frequency deviation of the reader/writer 200 can be at least covered.

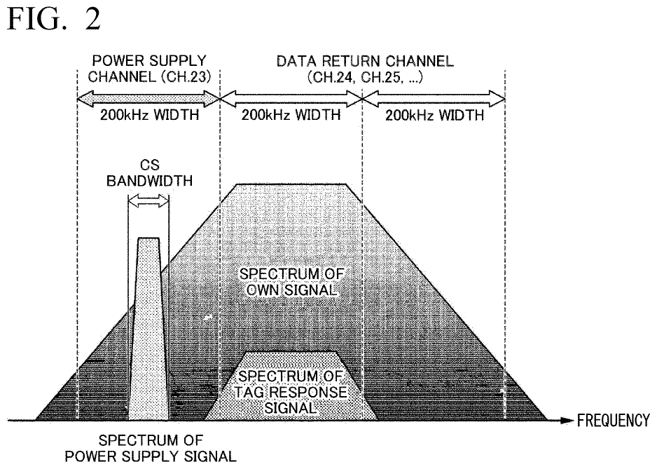

Specific description will be given with reference to FIG. 2.

FIG. 2 shows a spectrum 50 of a power supply signal, a spectrum 60 of the own signal, and a spectrum 70 of a tag response signal transmitted by the passive tag 400 to the reader/writer 200. For the spectrum 50 of the power supply signal as described in FIG. 2, for example, a 920 MHz band channel is 200 kHz wide per channel and the power supply signal is present in a narrow band of 200 kHz width of center frequency 920.4 MHz of Ch. 23.

Also, for the spectrum 60 of the own signal, one 200-kHz wide channel is used for the own signal, but the spectrum spreads precisely outside the 200 kHz width as shown in FIG. 2 (the spectrum spreads within a range satisfying the regulations of adjacent channel leakage power and unnecessary emission intensity defined by ARIB STD-T108 Version 1.4). Therefore, the spectrum 60 of the own signal spreads to the band of the channel of the power supply signal as shown in FIG. 2.

When power is calculated with 200 kHz width for a component spread to the band of the power supply channel, transmission signal power>power supply signal power is obtained, but transmission signal power<power supply signal power is obtained by narrowing the carrier-sense bandwidth in accordance with the narrow band of the power supply signal, and malfunction due to the transmission signal can be prevented.

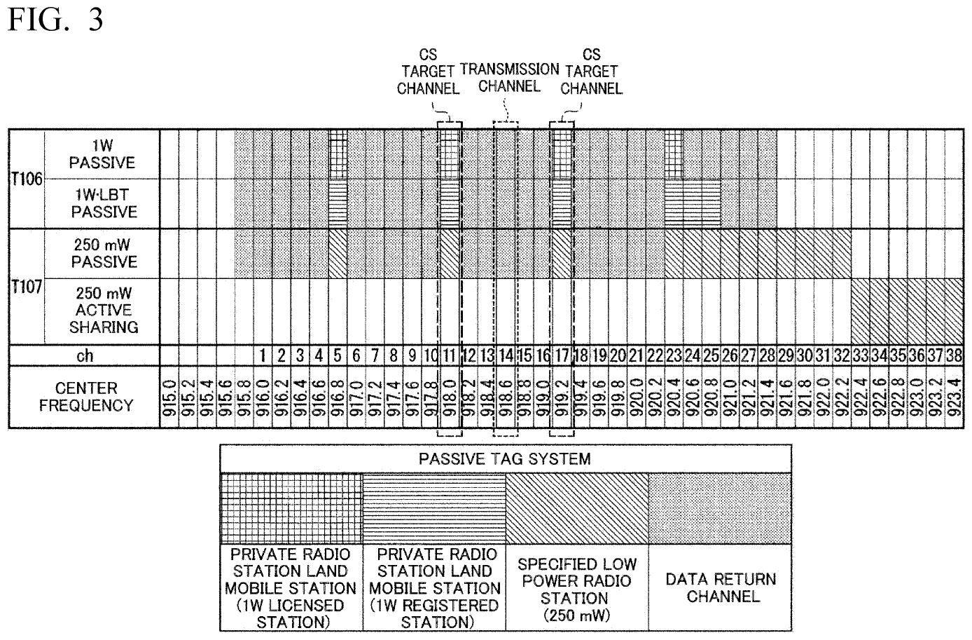

FIG. 3 is a diagram showing an example of a band to be subjected to carrier-sensing. FIG. 3 shows a channel (ch) and a center frequency for each standard (T106 (private wireless station land mobile station wireless equipment for identifying 920 MHZ band moving body) and T107 (specified low power wireless station wireless equipment for identifying 920 MHZ moving body)). FIG. 3 shows a private wireless station land mobile station (1 W licensed station), a specified low power wireless station (250 mW), and a data return channel.

For example, in a case where the wireless communication apparatus 100 transmits through Ch. 14 (“transmission channel” in the diagram), the carrier sensor 111 performs carrier-sensing for Ch.11 and Ch.17 (“CS target channels” in the diagram). In this manner, the carrier sensor 111 performs carrier-sensing before transmission of the own signal and during transmission of the own signal with respect to the power supply channels of the passive tag system on both sides of the transmission channel. It should be noted that a configuration is possible in which all the power supply channels are subjected to carrier-sensing at all times. In this case, however, the power consumption of the carrier sensor 111 increases. Further, as described above, carrier-sensing may be performed on a plurality of power supply channels in order in a time-division manner. Alternatively, the carrier sensor 111 may have a plurality of carrier sensors mounted thereon which may carry out carrier-sensing in parallel.

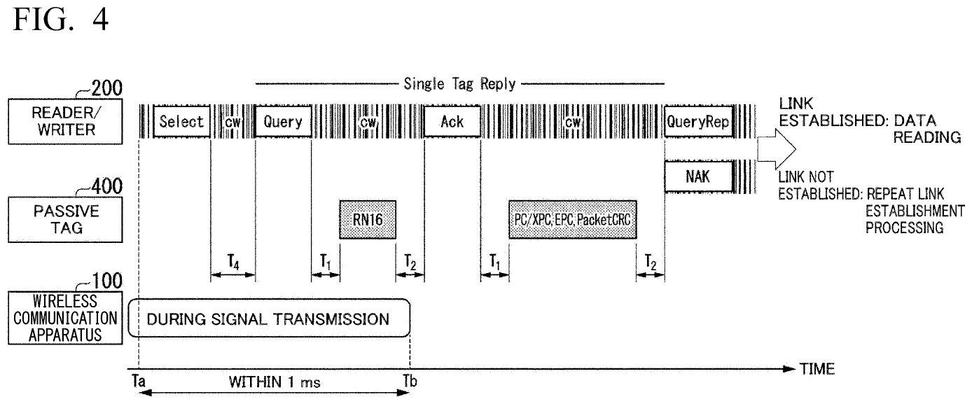

FIG. 4 is a sequence diagram showing a flow of processing performed when a power supply signal is detected by the carrier sensor 111. The horizontal axis of FIG. 4 represents the time. A signal transmitted by the reader/writer 200 and a signal transmitted by the passive tag 400 are shown.

In data reading by the passive tag 400, link establishment processing between the reader/writer 200 and the passive tag 400 is first performed. During the link establishment processing and data reading processing, the reader/writer 200 transmits a power supply signal. When a link is established by the link establishment processing, the passive tag 400 starts reading data. On the other hand, when the link is not established by the link establishment processing, the link establishment processing is performed again.

In FIG. 4, when the carrier sensor 111 detects a power supply signal at a time Ta during transmission of the own signal, the wireless communication apparatus 100 starts the processing for stopping the transmission of the own signal. Thus, the wireless communication apparatus 100 stops the transmission of the own signal at a time Tb. At this time, the transmission of the own signal is stopped so that the time from the time Ta to the time Tb is within, for example, 1 ms. Accordingly, the influence on the passive tag system 20 can be suppressed.

It should be noted that there is a possibility that the passive tag 400, which has responded to the link establishment processing, is affected by the time the stopping of the transmission by the wireless communication apparatus 100 is completed. In general, the reader/writer 200 periodically transmits a Query command to the passive tag 400 at intervals of several hundreds of μs. Therefore, the influence of the interference onto the passive tag 400 is such that a delay within 1 ms occurs in the data reading by the passive tag 400.

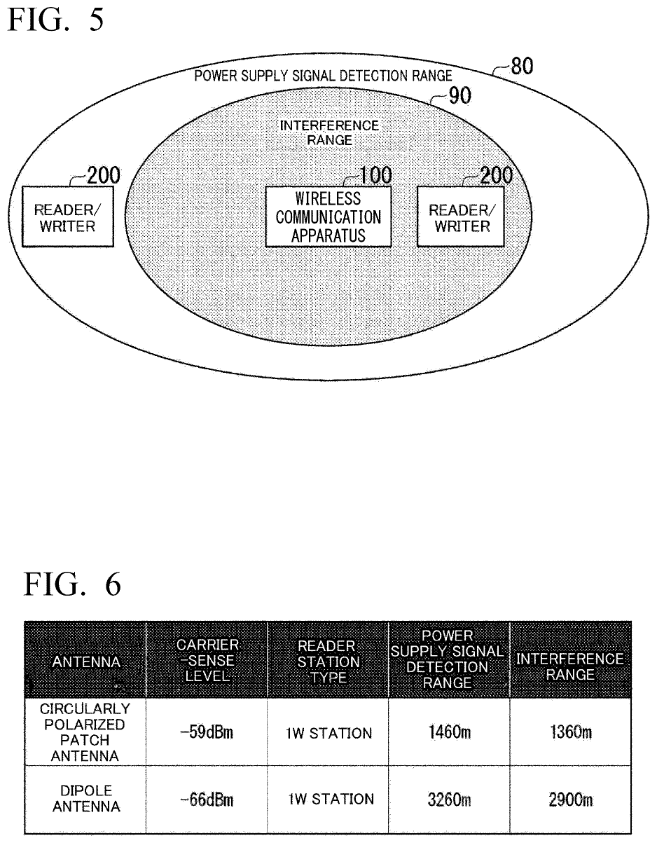

The next will describe a guideline for designing a carrier-sense level for preventing interference. FIG. 5 is a diagram for explaining a guideline for designing a carrier-sense level. In FIG. 5, a region 80 indicates a power supply signal detection range. A region 90 indicates an interference range.

A carrier-sense level of the carrier sensor 111 is set within a range in which the power supply signal detection range (region 80) is wider than the interference range (region 90) from the wireless communication apparatus 100. When the carrier-sense level is too high, the malfunction due to the own signal is eliminated, but a reader power supply signal detection range becomes narrow. On the other hand, if a distance level is too low, the power supply signal detection range becomes wide, but the malfunction due to the own signal occurs, and a signal cannot be transmitted.

Therefore, the carrier-sense level is set as shown in FIG. 6, for example. FIG. 6 is a diagram showing an example of setting a carrier-sense level. Examples of the type of the antenna to which the wireless communication apparatus 100 transmits the own signal include a circularly polarized wave patch antenna and a dipole antenna can be cited. Examples of an antenna for receiving a power supply signal include a dipole antenna.

FIG. 6 shows a carrier-sense level for each antenna type, a station type of the reader/writer 200, a power supply signal detection range, and an interference range. As shown in FIG. 6, when the wireless communication apparatus 100 transmits by the circularly polarized wave patch antenna, the carrier-sense level is set to −59 dBm. In this case, the power supply signal detection range is 1460 m with respect to the interference range 1360 m to the reader/writer 200 of the 1 W station.

When the wireless communication apparatus 100 transmits by the dipole antenna, the carrier-sense level is set to −66 dBm, so that the power supply signal detection range becomes 3260 m with respect to the interference range 2900 m to the reader/writer 200 of the 1 W station.

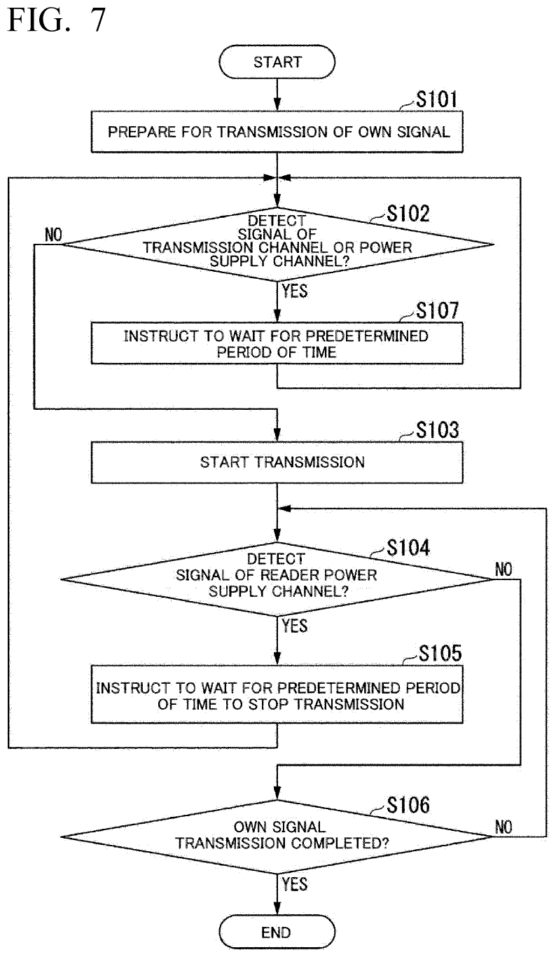

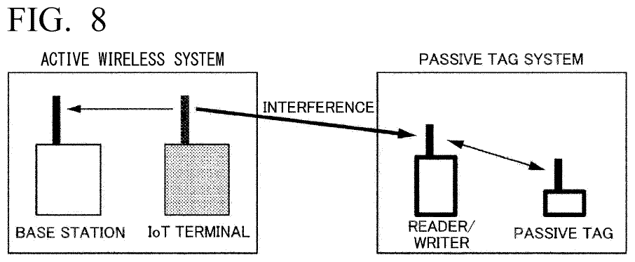

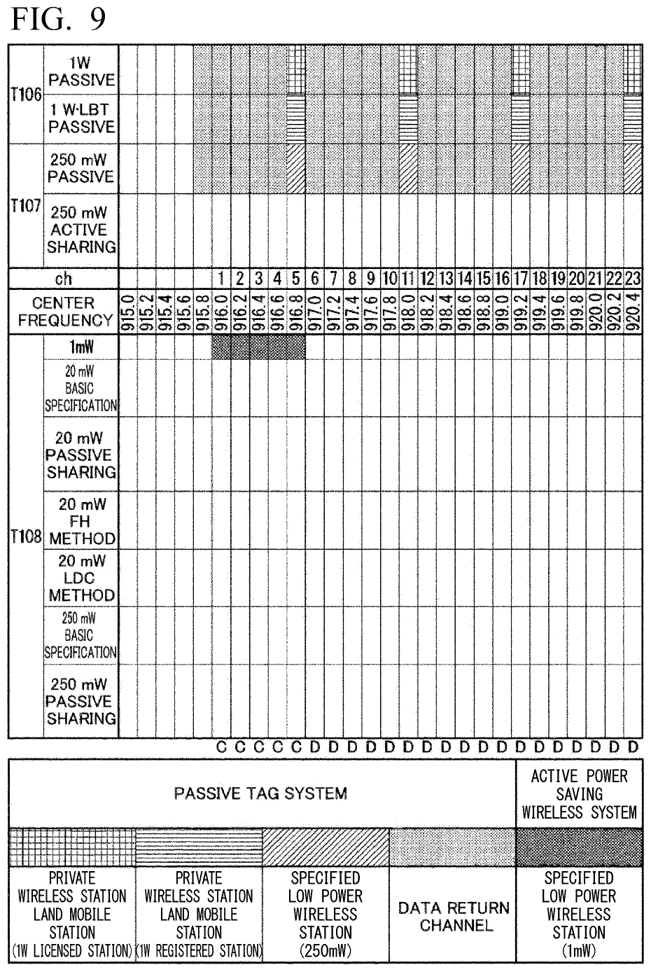

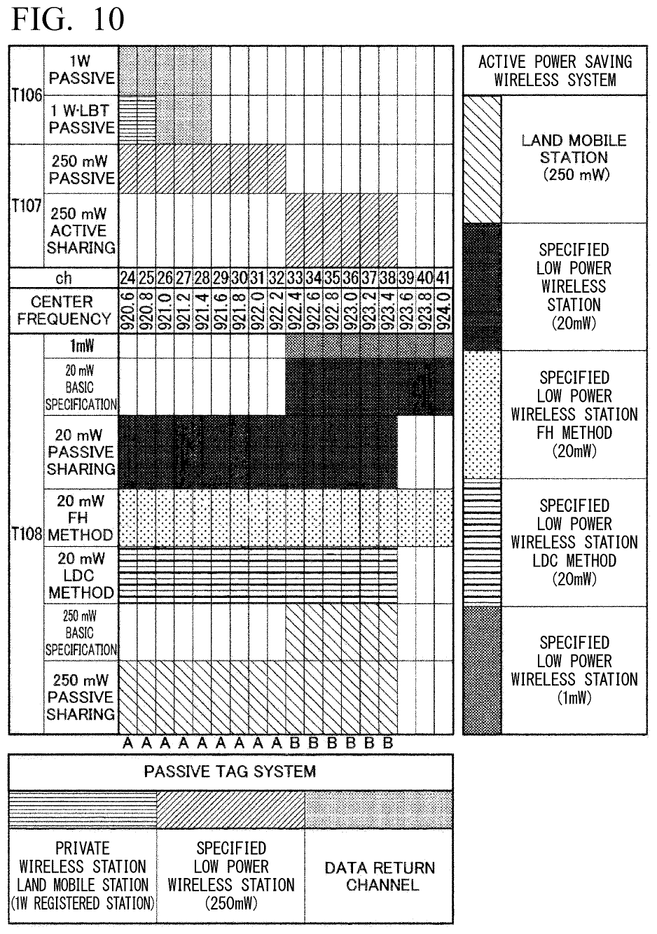

Next, a flow of processing of the wireless communication apparatus 100 will be described. FIG. 7 is a flowchart showing a flow of processing of the wireless communication apparatus 100. The wireless communication apparatus 100 prepares for transmission prior to transmission of the own signal (step S101). At this time, the controller 112 determines whether or not a signal of a transmission channel or a power supply channel of the own signal is detected by the carrier sensor 111 (step S102). In a case where the signal is detected (step S102: Yes), the controller 112 instructs the transmitter 120 to wait for a predetermined period of time for transmission of the own signal (step S107), and returns to step S102.

In a case where the signal is not detected in step S102 (step S102: No), the controller 112 causes the transmitter 120 to start transmission of the own signal (step S103). Thereafter, the controller 112 determines whether or not a signal of the power supply channel is detected by the carrier sensor 111 (step S104). In a case where the signal is detected (step S104: Yes), the controller 112 instructs the transmitter 120 to stop the transmission of the own signal, further instructs the transmitter 120 to wait for a predetermined period of time (step S105), and returns to step S102.

In a case where the signal is not detected in step S104 (YES in step S104), the controller 112 determines whether or not the transmission of the own signal is completed (step S106). In a case where the transmission has not been completed (step S106: No), the processing is returned to step S104. In a case where the transmission of the own signal is completed (step S106: Yes), this processing is ended.

As described above, in the present embodiment, the carrier-sensing is performed not only before the transmission of the own signal but also during the transmission. Thus, even during transmission of the own signal, in a case where the power supply signal is detected, the influence on the passive tag system 20 can be stopped by stopping the transmission of the own signal. Therefore, according to the present embodiment, the active wireless system and the passive tag system can favorably be shared.

The controller 112 may be configured using a processor such as a CPU (Central Processing Unit) and a memory. In this case, the controller 112 functions as the controller 112 when a processor executes a program. Note that all or some of the functions of the controller 112 may be realized by using hardware such as an ASIC (Application Specific Integrated Circuit), a PLD (Programmable Logic Device), or an FPGA (Field Programmable Gate Array). The above-mentioned program may be recorded in a computer-readable recording medium. The computer-readable recording medium is a portable medium such as a flexible disk, a magneto-optical disk, a ROM, a CD-ROM, or a semiconductor storage apparatus (e.g., SSD: Solid State Drive), or a storage apparatus such as a hard disk or a semiconductor storage apparatus incorporated in a computer system. The above-mentioned program may be transmitted via a

### Telecommunication Line.

Although the embodiment of the present invention has been described in detail with reference to the drawings, a specific configuration is not limited to this embodiment, and design within the scope of the gist of the present invention, and the like are included.

### Industrial Applicability

The present invention is applicable to a system in which an active wireless system and a passive tag system are shared at the same frequency.

### Reference Signs List

1 Wireless communication system
10 Active wireless system
20 Passive tag system
100 Wireless communication apparatus
111 Carrier sensor
112 Controller
120 Transmitter
130 Transmission data storage
200 Reader/writer
210 Transmitter
300 Base station
310 Communicator
400 Passive tag

1. A wireless communication apparatus, comprising:
a processor; and
a storage medium having computer program instructions stored thereon, when executed by the processor, perform to:
perform carrier-sensing before transmission of a signal with respect to a transmission channel of the wireless communication apparatus and perform carrier-sensing before transmission of a signal with respect to a channel used by a reader of a passive tag system; and
order signal transmission standby based on a result of carrier-sensing performed.

2. The wireless communication apparatus according to claim 1,
wherein the computer program instructions perform carrier-sensing even during transmission of a signal with respect to a channel used by the reader, and
order signal transmission stop based on a result of carrier-sensing performed during signal transmission.

3. The wireless communication apparatus according to claim 2,
wherein the computer program instructions set a carrier-sense bandwidth obtained when performing carrier-sensing of a channel used by the reader, within a range in which a transmission frequency deviation of the reader can be at least covered.

4. The wireless communication apparatus according to claim 2,
wherein the computer program instructions set a carrier-sense level within a range in which a power supply signal detection range is wider than an interference range of interference by a signal transmitted.

5. The wireless communication apparatus according to claim 2,
wherein the computer program instructions perform carrier-sensing on a plurality of channels used by the reader, in order in a time-division manner.

6. The wireless communication apparatus according to claim 2,
wherein the computer program instructions perform carrier-sensing on a plurality of channels used by the reader, in parallel.

7. A control method of a wireless communication apparatus, the control method comprising:
performing carrier-sensing before transmission of a signal with respect to a transmission channel of the wireless communication apparatus and performing carrier-sensing before transmission of a signal with respect to a channel used by a reader of a passive tag system; and
ordering signal transmission standby based on a result of carrier-sensing performed.
